(19) United States
(12) Patent Application Publication
(10) Pub. No.: US 2007/0285938 A1
(43) Pub. Date: Dec. 13, 2007

(54) Visibility Enhancing Pattern for a Light Producing Wheel Structure

(75) Inventors: Jesse N. Palmer, Greenville, NC (US); Barry L. Allen, Farmville, NC (US)

Correspondence Address: COATS & BENNETT, PLLC, 1400 Crescent Green, Suite 300, Cary, NC, 27518, US

(73) Assignee: LUNASEE LLC, Greenville, NC (US)

(21) Appl. No.: 11/758,812

(22) Filed: Jun. 6, 2007

Related U.S. Application Data
(60) Provisional application No. 60/804,303, filed on Jun. 9, 2006.

(51) Int. Cl. B60Q 1/26

(52) U.S. Cl. 362/500

(57) ABSTRACT

Rotation of a wheel assembly having phosphorescent pigments of differing visages creates a visual effect, such as a flashing or strobing appearance, not seen while the wheel is stationary. The arrangement of multiple visages of phosphorescent pigment may be within a single band or other shape or multiple bands or shapes on the same wheel assembly. This effect is created by varying the color, tone, color saturation, and/or pigment brightness of the phosphorescent material, along the side(s) of the wheel assembly. While the phosphorescent material is charged and glowing, and the wheel assembly rotates, the different visages will appear to the human eye to visually overlap. With this effect, the wheel assembly is given a strobing, flashing, or vibrating appearance. Other approaches, including different colors of phosphorescent material on the front and rear wheels, are also disclosed for enhancing visibility.

This application claims the benefit of U.S. Provisional Application No. 60/804,303, filed 9 Jun. 2006.

### FIELD OF THE INVENTION

The present invention relates to wheeled vehicle safety at night and/or under low lighting conditions, and in particular to enhancing the visual conspicuousness of light producing wheel structures viewed from a side angle.

### BACKGROUND OF THE INVENTION

Presently, there are various means for enabling a rotating wheel to produce light. For example, wheels/tires may have phosphorescent compounds, with the phosphorescent compounds glowing after being exposed to sunlight and other forms of ultraviolet light for an amount of time. The phosphorescent compounds are commonly arranged on the wheel or tire in a plurality of bands or other shapes of a single glowing pigment color. See, for example, U.S. Patent Application Publication No. 2004/0196647. However, it may be desirable in some situations to make the wheel/tire even more eye-catching. As such, there remains a need for alternative approaches.

### SUMMARY OF THE INVENTION

In one embodiment, the present invention is an arrangement of multiple visages of phosphorescent pigment within a single band or other shape or multiple bands or shapes on the same wheel, which upon rotation create a visual effect not seen while the wheel is stationary. One desired effect is a flashing or strobing appearance. This effect is created by varying the “visage” of the phosphorescent material along the lateral side(s) of the wheel, such as along the sidewall of the tire and/or along the rim. As used herein, “visage” means the combination of color, tone, color saturation, and emitted brightness of the phosphorescent material at a uniform charge level. While the phosphorescent material is charged and glowing, and the wheel or tire rotates, the different phosphorescent material segments will appear to the human eye to visually overlap, either entirely or partially. Due to the differing visages, the wheel assembly will appear to have a strobing or flashing appearance. This effect is not achievable using a single uniform continuous configuration of phosphorescent pigment upon a rotating wheel or tire. The various phosphorescent segments of a given visage may be of differing shapes, but advantageously are of uniform shape. And, the various phosphorescent segments of differing visages may be of the same or differing shapes.

Another approach for creating a visually enhanced phosphorescent appearance is to have different color phosphorescent pigments in front and rear tires. In this manner, the front of the vehicle may be discernible from the rear of the vehicle in the dark while the pigment is glowing, even if the vehicle is stationary.

Another approach is to form the phosphorescent sections with selected shapes chosen in such a manner as to cause the human eye to form shapes and characters from the blending of shapes and colors as a result of the stroboscopic effect as the wheel or tire is turned.

### BRIEF DESCRIPTION OF THE DRAWINGS

FIG. 1 shows a side view of a bicycle wheel having intermittent phosphorescent material sections upon the tire sidewall that uses complementary colors.

FIG. 2 shows a side view of a bicycle wheel having intermittent phosphorescent material sections upon the tire sidewall that uses analogous colors.

FIG. 3 shows a side view of a bicycle wheel having a single ring of phosphorescent material having an alternating pattern in solid bands of white and a second color.

FIG. 4 shows a side view of a bicycle wheel having a single ring of phosphorescent material having a different alternating pattern of complementary colors.

FIG. 5 shows a side view of a bicycle wheel having intermittent phosphorescent material sections upon the tire sidewall arranged in shape and spacing to form a word or image to the viewer as the tire is rotated.

FIG. 6 shows a side view of a bicycle wheel having mag rims having intermittent phosphorescent material sections upon the sides.

FIG. 7 shows a side view of a bicycle having a front and rear wheels with different color phosphorescent pigments, such as white and red.

### DETAILED DESCRIPTION OF THE INVENTION

In some embodiments, the present invention is an arrangement of multiple phosphorescent visages within a single band or other shape, or multiple bands or shapes, on the same wheel assembly. With the phosphorescent material charged and glowing, and the wheel assembly rotating, the different visages will appear to the human eye to visually overlap (either completely or partially). With this effect, the wheel assembly will visual effect not seen while the wheel assembly is stationary, such as having a strobing, flashing, and/or vibrating appearance. The approach may use alternating clashing colors, varied tones, variations in color saturation, and variation in pigment brightness of the phosphorescent material along the lateral side or sides of the wheel and/or tire.

There are some combinations of colors and tones that are particularly suited for this application. Colors that are known to be opposite on the color chart are very effective for this use. These combinations include red and green, blue and orange, purple and yellow. These colors are commonly known as the complementary colors. Another method would involve using a bright color such as white in combination with another color or colors. The variance in the brightness of the colors creates a flashing appearance. The use of spacing between phosphorescent segments can break the glow pattern enough to cause a blinking effect while the wheel is rotated.

Another approach is to use multiple colors of an analogous color group. Analogous colors are the colors on a standard color chart which lay to either side of a third color. An example would be the use of orange, yellow-orange, and yellow. Another example of this is the use of blue, blue-green, and green. This usage of analogous colors on a rotating wheel or tire may cause a single color to appear, but with an observable surface tension or vibrating effect.

In addition to complementary and analogous color combinations, the colors may alternatively be triadic, tetradic, or split-complementary. Triadic are three colors that are at an even distance from each other on the color wheel. Tetradic is similar to triadic, but with four colors evenly spaced from each other on the color wheel. Split-complementary uses a color and the two colors on either side of its complementary color. Further still, a monochromatic approach may be used, with a variation in tones for a single color. An example of this latter approach is bright red, dark red, and faded out red.

These and other methods of creating a visually enhanced phosphorescent appearance are discussed below. It should be noted that, for simplicity, the invention is discussed below generally in the context of a bicycle. However, the present invention is not limited to bicycles, but may instead be used on any wheels and/or tires, such as on motorcycles, baby strollers, or the like, as is appropriate.

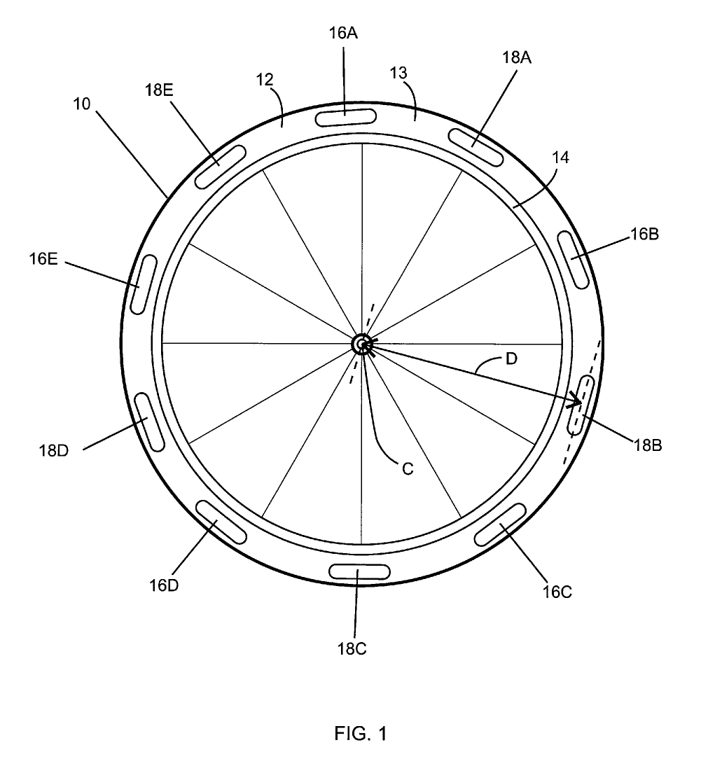

FIGS. 1-4 depict a bicycle wheel assembly, generally indicated at 10. The wheel assembly 10 typically includes a tire 12 mounted on a conventional spoked wheel structure having a generally peripheral rim 14. The wheel 10 rotates about a rotational axis or center C. The tire 12 includes lateral sidewalls 13 that face generally opposite lateral directions. In most embodiments, the relevant phosphorescent material is located on one or both lateral sidewalls 13 so that the center thereof is spaced from the rotational axis C by distance D. The phosphorescent material may be securely disposed to the wheel 10, including the tire 12 and/or rim 14, by any suitable means, such as by adhesives, spray coated, thermal bonding, being integrally molded thereto, or the like. See U.S. Pat. No. 7,001,051 to Palmer et al., and in U.S. patent application Ser. No. 11/346,956, filed 3 Feb. 2006, the disclosures of which are both incorporated herein by reference. While not shown in FIG. 1, the relevant phosphorescent material may alternatively, or additionally, located on the lateral side of the wheel structure, such as on the rim 14.

In FIG. 1, a series of phosphorescent material segments 16A-E of a first visage color are located at equal distance from each other along the sidewall 13. A second series of phosphorescent material segments 18A-E are located at equal distance from each other along the sidewall in an alternating pattern with segments 16A-E. The second segments 18A-E are of a color complementary to the color of the first segments 16A-E. As the wheel 10 rotates, the segments 16A-E, 18A-E, upon being charged to glow, visually blend to create a flashing or strobing effect. A further embodiment (not shown) may be similar to that of FIG. 1, but with three or more interspaced series of segments, each of a different visage. For example, with three series, the visages may be related such that their respective colors are triadic colors.

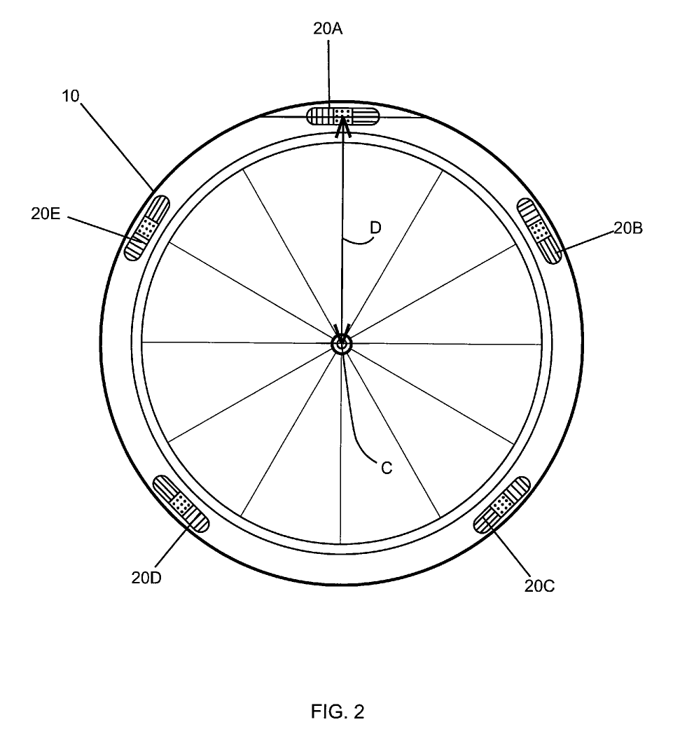

In FIG. 2, a series of phosphorescent material segments 20A-E are disposed in circumferentially spaced relation to each other along the sidewall 13 of tire 12 of wheel 10, advantageously in a radially symmetric configuration. Segments 20A-E each have three sections containing a separate color from the same analogous color scheme. Each segment 20A-E is advantageously arranged with the same analogous color scheme lined up in the same color order. As the wheel 10 rotates, the segments 20A-E, upon being charged to glow, visually blend to create a flashing or strobing effect.

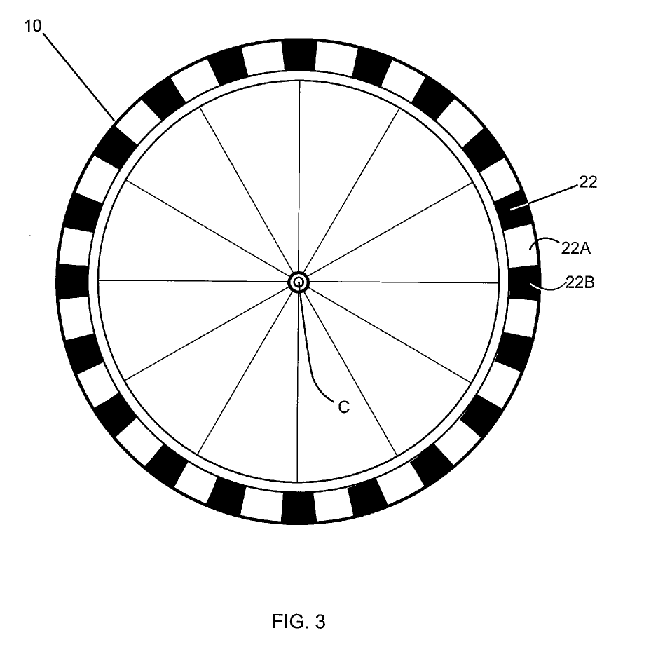

In FIG. 3, a ring 22 of phosphorescent material is located along the sidewall 13 of the wheel 10 at a location that is spaced from the rotational axis C of wheel 10. The ring 22 of phosphorescent material includes an alternating pattern of generally radial stripes of white 22a and another color 22b. As the wheel 10 rotates, the ring 22, upon being charged to glow, visually blends the white stripes 22a with the other color stripes 22b to create a flashing or strobing effect.

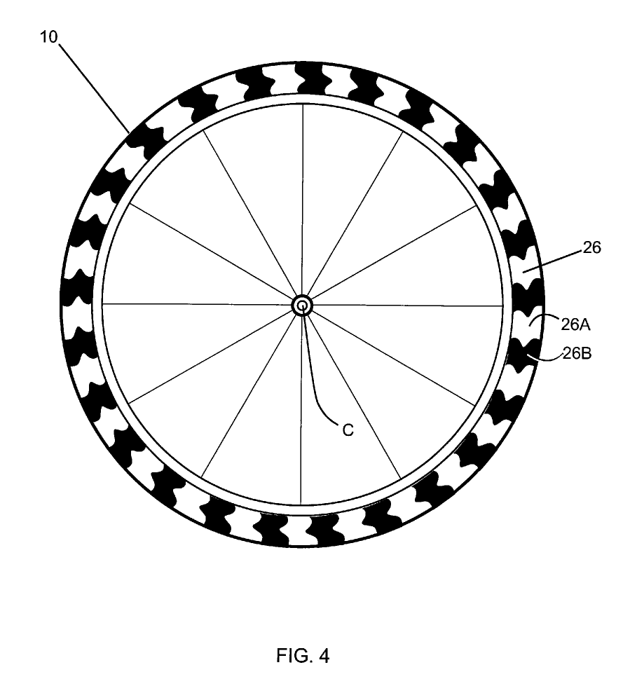

In FIG. 4, a solid ring 26 of phosphorescent material is located along the sidewall of wheel 10, in spaced relation to rotational axis C. The ring 26 of phosphorescent material is adorned with an alternating pattern of irregularly shaped segments 26a,26b of a color and it's complementary color. As the wheel 10 rotates, the ring 26 of phosphorescent material, upon being charged to glow, visually blends the segments 26a,26b to create a flashing or strobing effect.

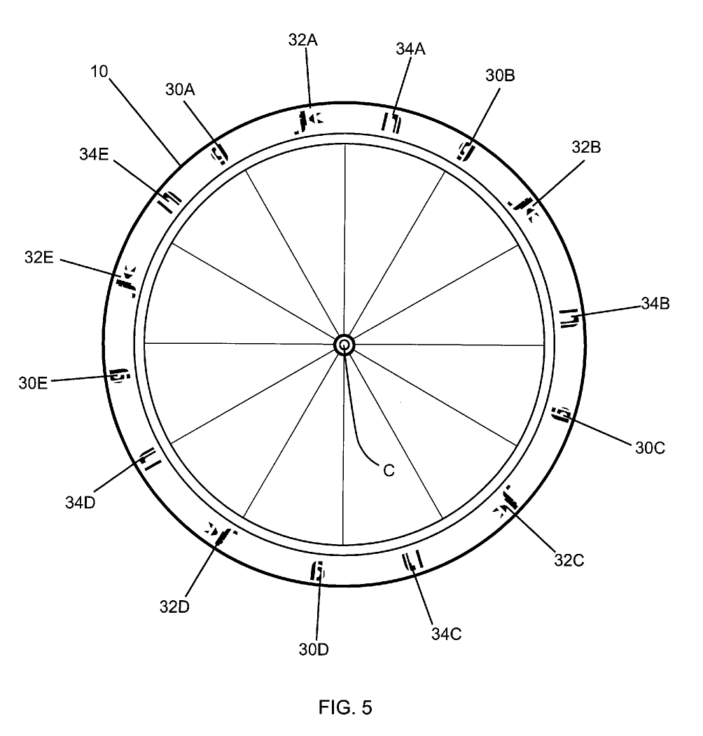

FIG. 5 depicts another bicycle wheel 10 with three series 30A-E, 32A-E, 34A-E of phosphorescent material segments disposed in circumferentially spaced relation to each other along the sidewall 13 and in spaced relation from rotational axis C. The series 30A-E, 32A-E, 34A-E are interspaced so that a segment from the first series 30A-E is followed by a segment from the second series 32A-E and then a segment from the third series 34A-E, followed by the next segment from the first series 30A-E, and so forth in a repeating cycle. The segments may have any appropriate shape, and are typically irregular in shape (as contrasted with the regular shapes depicted in FIG. 1). As the wheel 10 rotates, the segments of the series 30A-E, 32A-E, 34A-E, upon being charged to glow, visually blend to form a recognizable symbol, picture, word, or character(s), or combination thereof—generically an indicia.

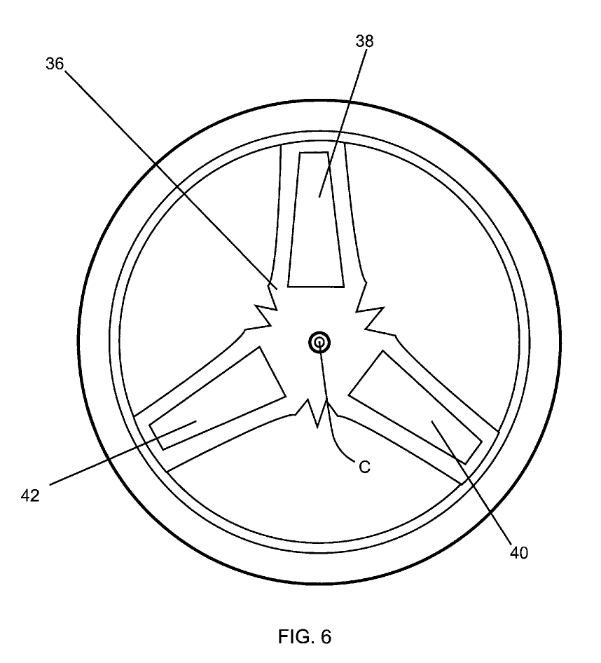

FIG. 6 depicts a “mag” style wheel for a bicycle with a tire, generally indicated at 36. An area 38 having phosphorescent material is located along the side of the mag wheel 36, along a spoke, and disposed in spaced relation from the rotational axis C. A second area 40 having phosphorescent material analogous in color to the first area 38 is located along another spoke. A third area 42 having phosphorescent material analogous in color to areas 38,40 is located along the remaining spoke. As the wheel 36 rotates, the areas 38,40,42 of phosphorescent material, upon being charged to glow, visually blend to create a flashing or strobing effect.

Most of the embodiments are described above in the context of using different colors. However, as discussed above the desired effect may alternatively be achieved by varying the color, hues, tones, color saturation, and/or pigment brightness of the phosphorescent material. Accordingly, as used in the following claims, the term “visage” is intended to mean a combination of color, tone, color saturation, and emitted brightness of the phosphorescent material at a uniform charge level. Thus, phosphorescent materials of two different visages may have the same color, hue, and tone, but have a different color saturation; or may be of the same color saturation, but of different colors.

Many of the embodiments discussed above utilize phosphorescent segments of different visages that are disposed at a substantially common radial distance D from the rotational center. Such an arrangement is believed advantageous. However, some variability in radial distance between the phosphorescent segments of different visage sets, and between the phosphorescent segments of a single visage set, is also envisioned. Provided the relevant phosphorescent segments appear to visually overlap (entirely or partially) when the wheel assembly is rotated, the desired effect may be achieved, and such is within the present invention.

Further, while many of the embodiments discussed above utilize phosphorescent segments located on the sidewall 13 of tire 12, it should be noted that, in some embodiments, other portions of the tire 12 may additionally include phosphorescent material, such as on the opposing lateral side, and/or in or on the tread. Further, for embodiments that utilize phosphorescent material on the wheel structure (e.g., rim 14), the phosphorescent material may extend inward all the way to the rotational axis of the wheel structure, but the portion of such phosphorescent material disposed away from the rotational axis (even if closer to the rotational axis than the perimeter) should be considered as the relevant phosphorescent material that is disposed at a position spaced from the rotational center. In some embodiments, the phosphorescent material may not be present any closer to the rotational center than the innermost portion of the circular rim 14 (e.g., the surface where the outboard end portion of spokes attach); in other embodiments, the phosphorescent material may be located inboard thereof.

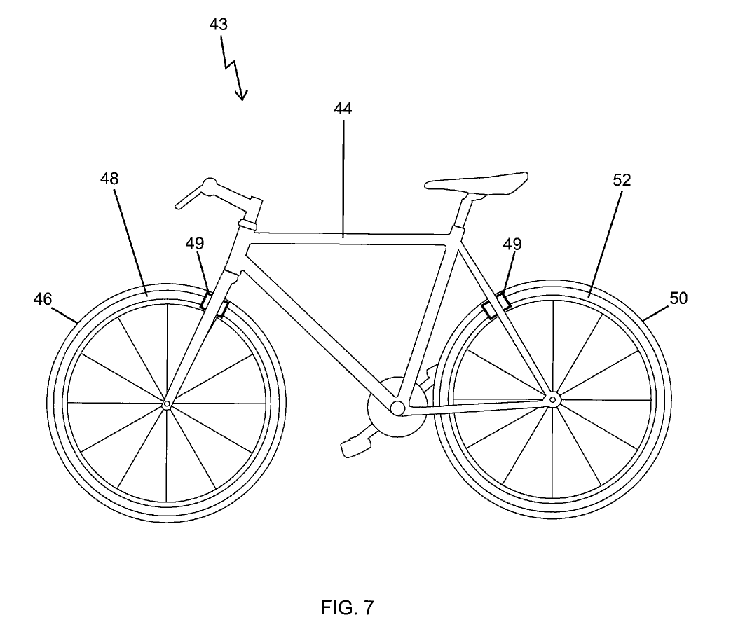

FIG. 7 depicts a bicycle of any conventional type, generally indicated at 43, having a frame 44, a front wheel 46, and a rear wheel 50. One or more phosphorescent chargers 49, such as battery or generator powered ultraviolet LEDs, may be mounted to frame 44, and associated with one or both wheels 46,50 for charging the phosphorescent sections associated with the corresponding wheel(s) 46,50 so as to make the same glow. Additional details of a bicycle or other wheeled vehicle, and phosphorescent chargers, may be found in U.S. Pat. No. 7,001,051, and in U.S. patent application Ser. No. 11/346,956, incorporated by reference above. Any of the phosphorescent material arrangements of the various embodiments discussed above may be used in conjunction with bicycle 44. Further, in one embodiment, the front wheel 46 has at least one phosphorescent section 48 located on the surface of a first color (e.g., white) and the rear wheel 50 has at least one phosphorescent section 52 located upon its surface of a second color (e.g. red). The phosphorescent sections 48,52 may be disposed on the tire, on the rim, or any other portion of wheel, advantageously in spaced relation to the rotational axis of the respective wheel. As the phosphorescent sections 48,52 are activated to glow, an onlooker may determine the front wheel 46 from the rear wheel 50, without the need to view the rest of the bicycle 44. It should be noted that the front wheel 46 and the rear wheel 50 may also have other phosphorescent sections, other than sections 48,52, that may optionally have the same or different visages. For example, the front wheel 46 may have red, white, and blue sections, while the rear wheel 50 may have red, white, and green sections. For such a scenario, the blue section acts as section 48, while the green section acts as section 52.

The present invention may, of course, be carried out in other specific ways than those herein set forth without departing from the essential characteristics of the invention. Indeed, the aspects of the various embodiments, including phosphorescent material location on the wheel assembly, shape, etc., may be combined as desired. Thus, the disclosed embodiments are therefore to be considered in all respects as illustrative and not restrictive, and all changes coming within the meaning and equivalency range of the appended claims are intended to be embraced therein.

What is claimed is:

1. A wheeled vehicle comprising:
at least one rotatably mounted wheel assembly;
a first plurality of phosphorescent sections of a first visage disposed on a lateral face of said wheel assembly at a position spaced from a rotational axis of said wheel assembly;
a second plurality of phosphorescent sections of a second visage, different from said first visage, disposed on said lateral face such that said first and second sections appear to at least partially visually overlap when said wheel assembly is rotated and said phosphorescent sections are charged.

2. The wheeled vehicle of claim 1 wherein said first and second visages differ in color.

3. The wheeled vehicle of claim 2 wherein said first and second visages are related such that the respective colors thereof are complementary.

4. The wheeled vehicle of claim 2 wherein said first and second visages are related such that the respective colors thereof are analogous.

5. The wheeled vehicle of claim 1 wherein said first visage is white in color and said second visage is non-white in color.

6. The wheeled vehicle of claim 1 wherein said wheel assembly comprises a wheel and a tire, and wherein at least one of said first and second pluralities of phosphorescent sections are disposed on a sidewall of said tire.

7. The wheeled vehicle of claim 1 wherein said wheel assembly comprises a wheel and a tire, said wheel having a generally peripheral rim; and wherein at least one of said first and second pluralities of phosphorescent sections are disposed on said rim.

8. The wheeled vehicle of claim 1 wherein said first plurality of phosphorescent sections are uniform in shape.

9. The wheeled vehicle of claim 1 further comprising a third plurality of phosphorescent sections of a third visage, different from both said first and second visages, disposed on said lateral face at a substantially similar radial distance as said first and second sections such that said first, second, and third sections appear to at least partially visually overlap when said wheel assembly is rotated.

10. The wheeled vehicle of claim 9 wherein said first, second, and third visages are related such that the respective colors thereof are related as triadic colors.

11. The wheeled vehicle of claim 1 wherein said wheeled vehicle is a bicycle.

12. The wheeled vehicle of claim 1 wherein said first plurality of phosphorescent sections are not uniform in shape and are disposed so as to at least partially visually overlap when said wheel assembly is rotated so as to form a visible indicia.

13. The wheeled vehicle of claim 12 wherein said first plurality of phosphorescent sections are shaped and disposed so as to at least partially visually overlap when said wheel assembly is rotated so as to form a visible word.

14. The wheeled vehicle of claim 1:
wherein said first and second visages differ in color;
wherein said wheel assembly comprises a wheel and a tire, said wheel having a generally peripheral rim;
wherein at least one of said first and second pluralities of phosphorescent sections are disposed on said rim.

15. An assembly comprising:
a wheel assembly comprising: a wheel having a rotational axis and a rim; a tire mounted to said wheel so as to rotate therewith;
a first plurality of phosphorescent sections of a first visage disposed on a lateral face of said wheel assembly at a position spaced from said rotational axis of said wheel;
a second plurality of phosphorescent sections of a second visage disposed on said lateral face such that said first and second pluralities of sections appear to at least partially visually overlap when said wheel is rotated.

16. The assembly of claim 15 wherein at least one of said first and second pluralities of phosphorescent sections are disposed on a sidewall of said tire.

17. The assembly of claim 15 wherein at least one of said first and second pluralities of phosphorescent sections are disposed on said rim.

18. The assembly of claim 15 wherein said first and second visages are related such that the respective colors thereof are complementary colors.

19. A wheeled vehicle comprising:
a frame;
a front wheel assembly rotatably mounted to said frame; said front wheel assembly having at least a first phosphorescent section of a first color disposed on a lateral face thereof at a position spaced from a rotational axis thereof;
a rear wheel assembly rotatably mounted to said frame; said rear wheel assembly having at least a second phosphorescent section of a second color, different from said first color, disposed on a lateral face thereof at a position spaced from a rotational axis thereof;
wherein said first and second phosphorescent sections face a common lateral side relative to said frame.

20. The wheeled vehicle of claim 19 further comprising a first and second phosphorescent chargers disposed in spaced relation from said front and rear wheels, respectively, and operative to charge said phosphorescent sections of the corresponding wheel assembly while said wheel assembly rotates.
